(19) United States
(12) Patent Application Publication
(10) Pub. No.: US 2009/0323705 A1
(43) Pub. Date: Dec. 31, 2009

(54) METHOD FOR IMPLEMENTING PHOTOELECTRIC MUTEX, ETHERNET PHOTOELECTRIC MUTEX INTERFACE DEVICE AND NETWORK EQUIPMENT

(75) Inventors: Ping Jin, Shenzhen (CN); Libao Chu, Shenzhen (CN); Xuefeng Zhang, Shenzhen (CN); Liqiang Zhang, Shenzhen (CN); Weiping Tian, Shenzhen (CN); Wei Wei, Shenzhen (CN); Guangtao He, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/491,422

(22) Filed: Jun. 25, 2009

(30) Foreign Application Priority Data
Jun. 30, 2008 (CN) 200810068189.2
May 21, 2009 (CN) PCT/CN2009/071910

(51) Int. Cl. H04L 12/66; H04L 12/56

(52) U.S. Cl. 370/401; 370/463

(57) ABSTRACT

A method for implementing photoelectric mutex, an Ethernet photoelectric mutex interface device, and network equipment are provided. The Ethernet photoelectric mutex interface device includes a channel switching module, a first Ethernet physical layer (PHY) chip, and a second Ethernet PHY chip. The channel switching module is connected to the first Ethernet PHY chip through a first interface and connected to the second Ethernet PHY chip through a second interface respectively, and is adapted to perform data transmission through the first Ethernet PHY chip and when a presence signal of an optical interface data transmission module is detected, perform data transmission through the second Ethernet PHY chip. Thus, a cost of equipment for implementing a photoelectric mutex function in an Ethernet is reduced, and a utilization rate of transmission resources is improved.

### CROSS-REFERENCE TO RELATED APPLICATIONS

This application claims priority to Chinese Patent Application No. 200810068189.2, filed on Jun. 30, 2008, and International Application No. PCT/CN2009/071910, filed on May 21, 2009, both of which are hereby incorporated by reference in their entirety.

### FIELD OF THE TECHNOLOGY

The present disclosure relates to the field of communication technology, and more particularly to a method for implementing photoelectric mutex, an Ethernet photoelectric mutex interface device, and network equipment.

### BACKGROUND

The photoelectric mutex means that a board physically supports two modes, that is, an optical interface mode and an electrical interface mode, but supports only one mode in operation, that is, the optical interface becomes unavailable after the electrical interface is plugged, and the electrical interface becomes unavailable after the optical interface is plugged. The photoelectric mutex is a mature technology in Gigabit Ethernet (GE) applications. Currently, all physical layer (PHY) chips of the GE support the photoelectric mutex technology. However, in many 100M Ethernet applications, that is, Fast Ethernet (FE) applications, PHY chips of the FE do not support the photoelectric mutex technology. Therefore, in mid-range-and-low-end products, the PHY chips of the GE are also used to implement the photoelectric mutex function.

In the current photoelectric mutex technology, the photoelectric mutex technology of the GE adopts a gigabit media access control (GMAC) controller and PHY chips of the GE to implement the photoelectric mutex function. Once a PHY chip of the GE samples a presence signal of an optical module, the PHY chip of the GE configures and modifies associated registers to switch to an optical interface mode, and establishes an adaptive connection with an optical interface data transmission module 100 BASE-FX, thereby supporting 100M optical interface network data transmission at the optical interface. Otherwise, the PHY chip of the GE adopts the electrical interface mode, and establishes an adaptive connection with an electrical interface data transmission module 10/100/1000 BASE-TX, thereby supporting 10M, 100M, and 1000M adaptive electrical interface network data transmission at the electrical interface.

During the implementation of the present disclosure, the inventors found that in the existing products, the solution of utilizing the GMAC controller and the PHY chips of the GE to implement the photoelectric mutex function is generally adopted to support the photoelectric mutex of the products. However, this solution has an excessively high cost, so the performance price ratio is rather low, and the products become less competitive in the mid-range-and-low-end market. In addition, the Gigabit transmission capability of the GMAC controller and PHY chips of the GE in the photoelectric mutex technology of the GE is not fully utilized, resulting in the waste of resources.

### SUMMARY

Embodiments of the present disclosure provide a method for implementing photoelectric mutex, an Ethernet photoelectric mutex interface device, and network equipment, to reduce the cost of a 100M Ethernet photoelectric mutex interface device in mid-range-and-low-end products and enhance a utilization rate of transmission resources.

In an embodiment, the present disclosure provides an Ethernet photoelectric mutex interface device. The device includes a channel switching module, a first Ethernet PHY chip, and a second Ethernet PHY chip.

The channel switching module is respectively connected with the first Ethernet PHY chip and the second Ethernet PHY chip, and is adapted to perform uplink or downlink data transmission through the first Ethernet PHY chip and when a presence signal of an optical interface data transmission module is detected, perform uplink or downlink data transmission through the second Ethernet PHY chip.

In an embodiment, the present disclosure further provides a method for implementing photoelectric mutex, which includes:
connecting with a first Ethernet physical layer (PHY) chip, and performing uplink or downlink data transmission through the first Ethernet PHY chip; and
switching the connection with the first Ethernet PHY chip to a connection with a second Ethernet PHY chip through a second interface when a presence signal of an optical interface data transmission module is detected, and performing uplink or downlink data transmission through the second Ethernet PHY chip.

In an embodiment, the present disclosure further provides network equipment, which includes a central processing unit (CPU) and an Ethernet photoelectric mutex interface device. The Ethernet photoelectric mutex interface device includes a channel switching module, a first Ethernet physical layer (PHY) chip, and a second Ethernet PHY chip.

The channel switching module is respectively connected with the first Ethernet PHY chip and the second Ethernet PHY chip, and is adapted to perform uplink or downlink data transmission through the first Ethernet PHY chip, and when a presence signal of an optical interface data transmission module is detected, perform uplink or downlink data transmission through the second Ethernet PHY chip.

Compared with the conventional art, the embodiments of the present disclosure adopt two Ethernet PHY chips with lower cost and a channel switching module to implement the photoelectric mutex, instead of realizing the photoelectric mutex of the Ethernet by adopting PHY chips with higher cost. Thus, the cost for implementing the photoelectric mutex of the Ethernet in products is reduced, and the utilization rate of resources is improved.

### BRIEF DESCRIPTION OF THE DRAWINGS

To illustrate the technical solutions according to the embodiments of the present disclosure or in the prior art more clearly, the accompanying drawings required for describing the embodiments or the prior art are introduced below briefly. Apparently, the accompanying drawings in the following descriptions are only some embodiments of the present disclosure, and persons of ordinary skill in the art can obtain other drawings according to the accompanying drawings without paying creative efforts.

FIG. 1 is a schematic diagram of an Ethernet photoelectric mutex interface device according to an embodiment of the present disclosure;

FIG. 2 is a flowchart of a method for implementing photoelectric mutex according to an embodiment of the present disclosure;

FIG. 3 is a flowchart of another method for implementing photoelectric mutex according to an embodiment of the present disclosure;

FIG. 4 is a schematic diagram of an Ethernet photoelectric mutex interface device according to an embodiment of the present disclosure;

FIG. 5 is a schematic diagram of an FPGA according to an embodiment of the present disclosure;

FIG. 6 is a flowchart of a method for implementing photoelectric mutex according to an embodiment of the present disclosure;

FIG. 7 is a flowchart of another method for implementing photoelectric mutex according to an embodiment of the present disclosure;

FIG. 8 is a schematic diagram of an Ethernet photoelectric mutex interface device according to an embodiment of the present disclosure;

FIG. 9 is a flowchart of a method for implementing photoelectric mutex according to an embodiment of the present disclosure;

FIG. 10 is a flowchart of another method for implementing photoelectric mutex according to an embodiment of the present disclosure;

FIG. 11 is a schematic diagram of network equipment according to an embodiment of the present disclosure;

FIG. 12 is a schematic diagram of another Ethernet photoelectric mutex interface device according to an embodiment of the present disclosure;

FIG. 13 is a flowchart of another method for implementing photoelectric mutex according to an embodiment of the present disclosure; and

FIG. 14 is a flowchart of another method for implementing photoelectric mutex according to an embodiment of the present disclosure.

### DETAILED DESCRIPTION

To make the objectives, technical solutions, and advantages of the present disclosure more comprehensible, the technical solutions according to the embodiments of the present disclosure are described below clearly and completely with reference to the accompanying drawings. Apparently, only a part of the embodiments of the present disclosure are described herein, that is, not all of the embodiments are described. All other embodiments obtained by persons of ordinary skill in the art on the basis of the embodiments of the present disclosure without paying creative efforts shall fall within the protective scope of the present disclosure.

### Embodiment 1

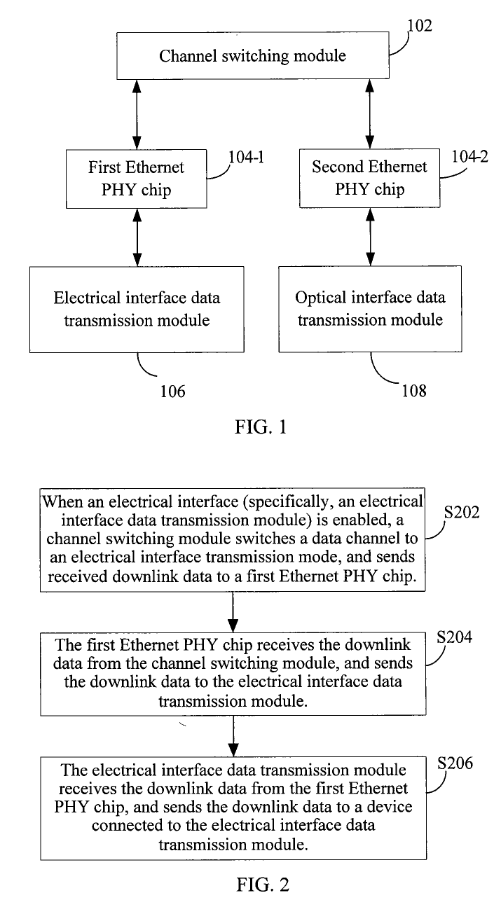

FIG. 1 is a schematic diagram of an Ethernet photoelectric mutex interface device according to an embodiment of the present disclosure. As shown in FIG. 1, the device includes a channel switching module 102, a first Ethernet PHY chip 104-1, a second Ethernet PHY chip 104-2, an electrical interface data transmission module 106, and an optical interface data transmission module 108.

The channel switching module 102 is adapted to switch a data channel to an electrical interface data transmission mode when an electrical interface (specifically, an electrical interface data transmission module) is enabled and send received downlink data to the first Ethernet PHY chip 104-1, and switch the data channel to an optical interface transmission mode when an optical interface (specifically, an optical interface data transmission module) is enabled and send received downlink data to the second Ethernet PHY chip 104-2. When the Ethernet photoelectric mutex interface device is powered on, the electrical interface can be valid by default, so that the electrical interface data transmission mode is enabled. Once an optical module is inserted into the device, an optical channel is established, and a LOSS signal of the optical module becomes valid. Upon sampling that the LOSS signal is valid, the channel switching module 102 switches to the optical interface data transmission mode to ensure the validity of the optical interface.

The first Ethernet PHY chip 104-1 is adapted to receive the downlink data from the channel switching module 102, and send the downlink data to the electrical interface data transmission module 106.

The second Ethernet PHY chip 104-2 is adapted to receive the downlink data from the channel switching module 102, and send the downlink data to the optical interface data transmission module 108.

The electrical interface data transmission module 106 is adapted to receive the downlink data from the first Ethernet PHY chip 104-1, and send the downlink data to a device (for example, a router or a switch) connected to the electrical interface data transmission module 106.

The optical interface data transmission module 108 is adapted to receive the downlink data from the second Ethernet PHY chip 104-2, and send the downlink data to a device (for example, a router or a switch) connected to the optical interface data transmission module 108.

FIG. 12 is a schematic diagram of Ethernet photoelectric mutex interface device according to another embodiment of the present disclosure. As shown in FIG. 12, the Ethernet photoelectric mutex interface device is applicable to a 100M Ethernet. The device includes a channel switching module 1202, a first Ethernet PHY chip 1204-1, and a second Ethernet PHY chip 1204-2. It is understandable that the channel switching module 1202 includes a first interface 1206-1 and a second interface 1206-2 in one realizable condition. That is, in another realizable condition, the Ethernet photoelectric mutex interface device further includes the first interface 1206-1 and the second interface 1206-2.The channel switching module 1202 is connected to the first Ethernet PHY chip 1204-1 through the first interface 1206-1 and is connected to the second Ethernet PHY chip 1204-2 through the second interface 1206-2 so that the channel switching module 1202 can perform data transmission through the first Ethernet PHY chip 1204-1, and to perform data transmission through the second Ethernet PHY chip 1204-2 when a presence signal of an optical interface data transmission module is detected.

In actual applications, the channel switching module 1202 in the photoelectric mutex interface device considers the first interface 1206-1 connected to the first Ethernet PHY chip 1204-1 as valid by default, that is, network data is transmitted in the electrical interface transmission mode through the first Ethernet PHY chip 1204-1. Once the presence signal of the optical interface data transmission module is detected, the channel switching module 1202 is switched to transmit the network data in the optical interface transmission mode through the second Ethernet PHY chip 1204-2 by using the second interface 1206-2. It should be noted that, the first interface 1206-1 and the second interface 1206-2 may be media independent interfaces (MIIs).

The photoelectric mutex interface device may further include an electrical interface data transmission module 1208-1, and an optical interface data transmission module 1208-2.

The electrical interface data transmission module 1208-1 is connected to the first Ethernet PHY chip 1204-1, and is adapted to perform data transmission with the channel switching module 1202 through the first Ethernet PHY chip 1204-1.

The optical interface data transmission module 1208-2 is connected to the second Ethernet PHY chip 1204-2, and is adapted to perform data transmission with the channel switching module 1202 through the second Ethernet PHY chip 1204-2.

In this embodiment, as shown in FIG. 12, the channel switching module 1202 may be a field programmable gate array (FPGA), or the channel switching module 1202 may include a media access control (MAC) module and an analog switching module. The first Ethernet PHY chip 1204-1 and the second Ethernet PHY chip 1204-2 may be, but not limited to, 100M Ethernet PHY chips. The electrical interface data transmission module 1208-1 may be a 10M/100M adaptive electrical interface data transmission module, and the optical interface data transmission module 1208-2 may be a 100M optical interface data transmission module.

In this embodiment of the present disclosure, two Ethernet PHY chips having low cost and a channel switching module are adopted to implement the photoelectric mutex of the 100M Ethernet, instead of realizing the photoelectric mutex function of the Ethernet by adopting PHY chips with higher cost (for example, PHY chips of the GE). Thus, the cost of the equipment for implementing the photoelectric mutex function of the Ethernet in products is reduced, and the utilization rate of resources is improved.

### Embodiment 2

FIG. 2 is a flowchart of a method for implementing photoelectric mutex by an Ethernet photoelectric mutex interface device according to an embodiment of the present disclosure. The method includes the following blocks.

In Block S202, when an electrical interface (specifically, an electrical interface data transmission module) is enabled, a channel switching module switches a data channel to an electrical interface transmission mode, and sends received downlink data to a first Ethernet PHY chip.

In Block S204, the first Ethernet PHY chip receives the downlink data from the channel switching module, and sends the downlink data to the electrical interface data transmission module.

In Block S206, the electrical interface data transmission module receives the downlink data from the first Ethernet PHY chip, and sends the downlink data to a device connected to the electrical interface data transmission module.

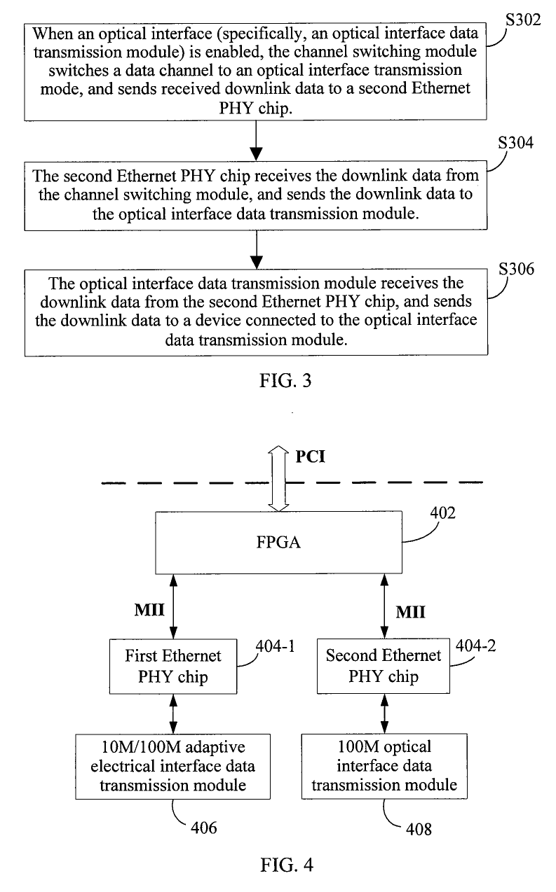

Alternatively, as shown in FIG. 3, the method can include the following blocks.

In Block S302, when an optical interface (specifically, an optical interface data transmission module) is enabled, the channel switching module switches a data channel to an optical interface transmission mode, and sends received downlink data to a second Ethernet PHY chip.

In Block S304, the second Ethernet PHY chip receives the downlink data from the channel switching module, and sends the downlink data to the optical interface data transmission module.

In Block S306, the optical interface data transmission module receives the downlink data from the second Ethernet PHY chip, and sends the downlink data to a device connected to the optical interface data transmission module.

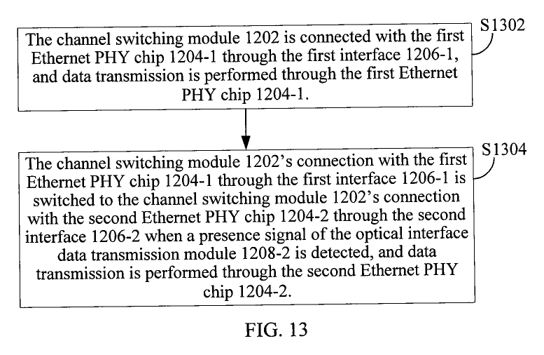

FIG. 13 is a schematic diagram of another method for implementing photoelectric mutex by the Ethernet photoelectric mutex interface device shown in FIG. 12 according to the above embodiment. The method includes the following blocks.

In Block S1302, the channel switching module 1202 is connected with the first Ethernet PHY chip 1204-1 through the first interface 1206-1, and data transmission is performed through the first Ethernet PHY chip 1204-1.

Specifically, the data transmission between the channel switching module 1202 connected to the first Ethernet PHY chip 1204-1 and the electrical interface data transmission module 1208-1 connected to the first Ethernet PHY chip 1204-1 is performed through the first Ethernet PHY chip 1204-1.

In Block S1304, the channel switching module 1202's connection with the first Ethernet PHY chip 1204-1 through the first interface 1206-1 is switched to the channel switching module 1202's connection with the second Ethernet PHY chip 1204-2 through the second interface 1206-2 when a presence signal of the optical interface data transmission module 1208-2 is detected, and data transmission is performed through the second Ethernet PHY chip 1204-2.

Specifically, once the presence signal of the optical interface data transmission module 1208-2 is detected, the data transmission between the channel switching module 1202 connected to the second Ethernet PHY chip 1204-2 and the optical interface data transmission module 1208-2 connected to the second Ethernet PHY chip 1204-2 is performed through the second Ethernet PHY chip 1204-2.

Apparently, person skilled in the art may appreciate that, the data transmission may include the downlink data transmission from the channel switching module 1202 to the electrical interface data transmission module 1208-1 or to the optical interface data transmission module 1208-2, and the downlink data is then transmitted by the electrical interface data transmission module 1208-1 or the optical interface data transmission module 1208-2. Similarly, the data transmission may include the uplink data transmission from the electrical interface data transmission module 1208-1 or the optical interface data transmission module 1208-2 to the channel switching module 1202, and the uplink data is then transmitted by the channel switching module 1202, for example, the uplink data is then transmitted to a central processing unit (CPU) connected to the channel switching module 1202.

In the method for implementing photoelectric mutex by the photoelectric mutex interface device according to the embodiment of the present disclosure, a solution of using two Ethernet PHY chips (for example, PHY chips of the FE) with lower cost and a channel switching module is adopted to implement the photoelectric mutex of the 100M Ethernet, instead of realizing the photoelectric mutex function by adopting high-end products (for example, PHY chips of the GE) in the existing products. Thus, the cost for implementing the photoelectric mutex in mid-range-and-low-end products is reduced, and the utilization rate of resources is improved.

### Embodiment 3

FIG. 4 is a schematic diagram of an Ethernet photoelectric mutex interface device according to an embodiment of the present disclosure. The device includes an FPGA 402, a first Ethernet PHY chip 404-1, a second Ethernet PHY chip 404-2, a 10M/100M adaptive electrical interface data transmission module 406 (for example, 10/100 BASE-TX), and a 100M optical interface data transmission module 408 (for example, 100 BASE-FX).

The FPGA 402 is connected to a CPU (which isn't illustrated) through a PCI bus, and is connected to the first Ethernet PHY chip 404-1 and the second Ethernet PHY chip 404-2 respectively.

The FPGA 402 is adapted to switch a data channel to an electrical interface transmission mode or an optical interface transmission mode according to a condition that an electrical interface or an optical interface is enabled, and receive downlink data from the CPU through the PCI bus. Particularly, when the electrical interface is enabled, the FPGA 402 sends the received downlink data to the first Ethernet PHY chip 404-1, and when the optical interface is enabled, the FPGA sends the received downlink data to the second Ethernet PHY chip 404-2. Correspondingly, the FPGA 402 also receives uplink data from the first Ethernet PHY chip 404-1 or the second Ethernet PHY chip 404-2 through a corresponding MII, and sends the uplink data to the CPU through the PCI bus. When the Ethernet photoelectric mutex interface device is powered on, the electrical interface is valid by default, and the electrical interface data transmission mode is enabled. Once an optical module is inserted into the device, an optical channel is established, and a LOSS signal of the optical module becomes valid. Upon sampling that the LOSS signal is valid, the FPGA 402 switches the data channel to the optical interface data transmission mode, and ensures the validity of the optical interface.

The first Ethernet PHY chip 404-1 is connected to the FPGA 402 in an uplink direction, and is connected to the 10M/100M adaptive electrical interface data transmission module 406 in a downlink direction. The first Ethernet PHY chip 404-1 is adapted to receive downlink data from the FPGA 402, and send the received downlink data to the 10M/100M adaptive electrical interface data transmission module 406. Correspondingly, the first Ethernet PHY chip 404-1 receives uplink data from the 10M/100M adaptive electrical interface data transmission module 406 through an MII, and sends the received uplink data to the FPGA 402.

The second Ethernet PHY chip 404-2 is connected to the FPGA 402 in the uplink direction, and is connected to the 100M optical interface data transmission module 408 in the downlink direction. The second Ethernet PHY chip 404-2 is adapted to receive downlink data from the FPGA 402, and send the received downlink data to the 100M optical interface data transmission module 408. Correspondingly, the second Ethernet PHY chip 404-2 receives uplink data from the 100M optical interface data transmission module 408 through an MII, and sends the received uplink data to the FPGA 402.

The 10M/100M adaptive electrical interface data transmission module 406 is connected to the first Ethernet PHY chip 404-1, and is adapted to receive the downlink data from the first Ethernet PHY chip 404-1. When the electrical interface is enabled, the 10M/100M adaptive electrical interface data transmission module 406 provides the received downlink data to the device connected to the 10M/100M adaptive electrical interface data transmission module 406, for example, a router or a switch. Correspondingly, when the electrical interface is enabled, the 10M/100M adaptive electrical interface data transmission module is adapted to 406 receive the uplink data from the device connected to the 10M/100M adaptive electrical interface data transmission module 406, and sends the uplink data to the first Ethernet PHY chip 404-1.

The 100M optical interface data transmission module 408 is connected to the second Ethernet PHY chip 404-2, and is adapted to receive the downlink data from the second Ethernet PHY chip 404-2. When the optical interface is enabled, the 100M optical interface data transmission module 408 provides the received downlink data to the device connected to the optical interface, for example, a router or a switch. Correspondingly, when the optical interface is enabled, the 100M optical interface data transmission module 408 is adapted to receive the uplink data from the device connected to the 100M optical interface data transmission module 408, and sends the uplink data to the second Ethernet PHY chip 404-2.

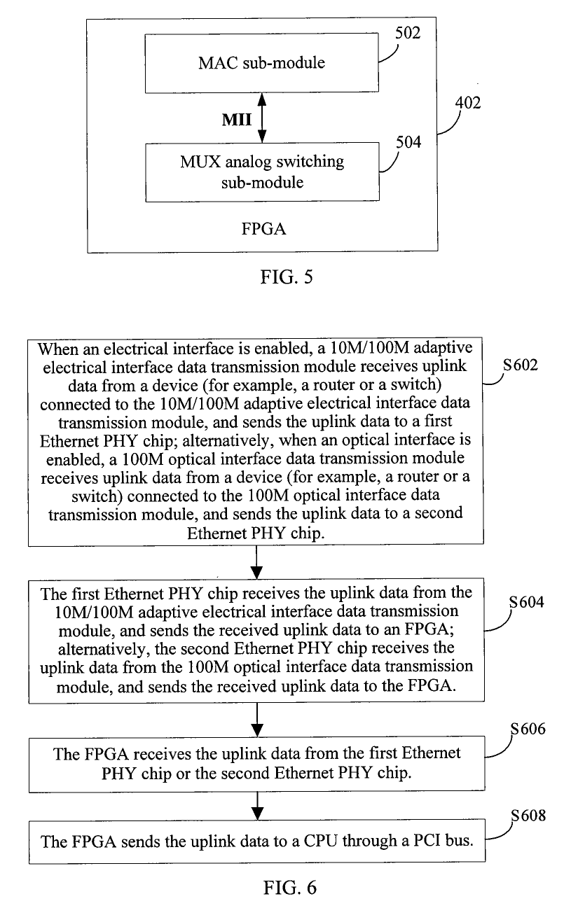

FIG. 5 is a schematic diagram of the FPGA 402 shown in FIG. 4. As shown in FIG. 5, in this embodiment, the FPGA 402 is adapted to realize the switching motion between a MAC function and a MUX control function. The FPGA 402 includes a MAC sub-module 502 and a multiplex (MUX) analog switching sub-module 504. The MAC sub-module 502 is connected to a CPU through a PCI bus, and is connected to the MUX analog switching sub-module 504 through an MII respectively.

The MAC sub-module 502 is adapted to provide different control information of a MAC layer.

Specifically, the function of the MAC sub-module 502 includes, but not limited to, converting downlink data received from the CPU through the PCI bus into data suitable for being transmitted in a physical layer of the Ethernet, or converting uplink data received from the physical layer of the Ethernet through the MII into data that can be transmitted to the CPU through the PCI bus.

The MUX analog switching sub-module 504 is adapted to enable a channel connected to the first Ethernet PHY chip 404-1 when no presence signal of the optical interface data transmission module 408 is detected, and perform data transmission between the CPU and the 10M/100M electrical interface data transmission module 406 through the first Ethernet PHY chip 404-1. When a presence signal of the 100M optical interface data transmission module 408 is detected, the MUX analog switching sub-module 504 is adapted to switch to a channel connected to the second Ethernet PHY chip 404-2 and perform data transmission between the CPU and the 100M optical interface data transmission module 408 through the second Ethernet PHY chip 404-2.

Apparently, person skilled in the art may appreciate that, the electrical interface data transmission module includes, but not limited to, the 10M/100M adaptive electrical interface data transmission module, and the optical interface data transmission module includes, but not limited to, the 100M optical interface data transmission module.

In this embodiment, the interfaces are, for example, the MII and the PCI. However, the interfaces are not limited here. The first Ethernet PHY chip and the second Ethernet PHY chip may be 100M Ethernet PHY chips and the like.

The photoelectric mutex interface device according to the embodiment of the present disclosure adopts the Ethernet PHY chips with lower cost and a channel switching module to implement the photoelectric mutex of the 100M Ethernet, instead of realizing the photoelectric mutex function of the Ethernet by using the PHY chips with higher cost. Thus, the cost of the equipment for implementing the photoelectric mutex function in products is reduced, and the utilization rate of resources is improved.

### Embodiment 4

FIG. 6 is a flowchart of a method for implementing photoelectric mutex by an Ethernet photoelectric mutex interface device according to an embodiment of the present disclosure. Referring to FIG. 6, in an uplink direction, the method includes the following blocks.

In Block S602, when an electrical interface is enabled, a 10M/100M adaptive electrical interface data transmission module receives uplink data from a device (for example, a router or a switch) connected to the 10M/100M adaptive electrical interface data transmission module, and sends the uplink data to a first Ethernet PHY chip; alternatively, when an optical interface is enabled, a 100M optical interface data transmission module receives uplink data from a device (for example, a router or a switch) connected to the 100M optical interface data transmission module, and sends the uplink data to a second Ethernet PHY chip.

In Block S604, the first Ethernet PHY chip receives the uplink data from the 10M/100M adaptive electrical interface data transmission module, and sends the received uplink data to an FPGA; alternatively, the second Ethernet PHY chip receives the uplink data from the 100M optical interface data transmission module, and sends the received uplink data to the FPGA.

In Block S606, the FPGA receives the uplink data from the first Ethernet PHY chip or the second Ethernet PHY chip.

In Block S608, the FPGA sends the uplink data to a CPU through a PCI bus.

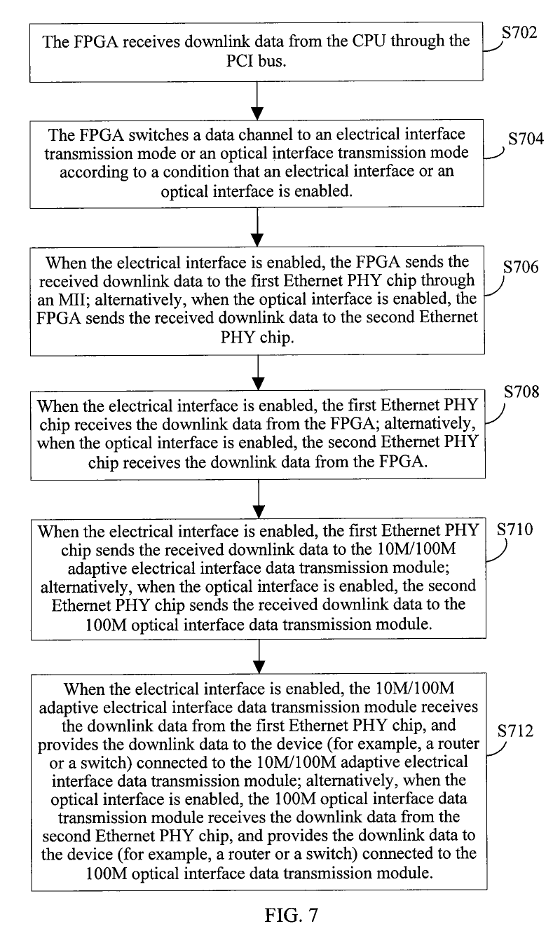

Referring to FIG. 7, in a downlink direction, the method includes the following blocks.

In Block S702, the FPGA receives downlink data from the CPU through the PCI bus.

In Block S704, the FPGA switches a data channel to an electrical interface transmission mode or an optical interface transmission mode according to a condition that an electrical interface or an optical interface is enabled.

In Block S706, when the electrical interface is enabled, the FPGA sends the received downlink data to the first Ethernet PHY chip through an MII; alternatively, when the optical interface is enabled, the FPGA sends the received downlink data to the second Ethernet PHY chip.

In Block S708, when the electrical interface is enabled, the first Ethernet PHY chip receives the downlink data from the FPGA; alternatively, when the optical interface is enabled, the second Ethernet PHY chip receives the downlink data from the FPGA.

In Block S710, when the electrical interface is enabled, the first Ethernet PHY chip sends the received downlink data to the 10M/100M adaptive electrical interface data transmission module; alternatively, when the optical interface is enabled, the second Ethernet PHY chip sends the received downlink data to the 100M optical interface data transmission module.

In Block S712, when the electrical interface is enabled, the 10M/100M adaptive electrical interface data transmission module receives the downlink data from the first Ethernet PHY chip, and provides the downlink data to the device (for example, a router or a switch) connected to the 10M/100M adaptive electrical interface data transmission module; alternatively, when the optical interface is enabled, the 100M optical interface data transmission module receives the downlink data from the second Ethernet PHY chip, and provides the downlink data to the device (for example, a router or a switch) connected to the 100M optical interface data transmission module.

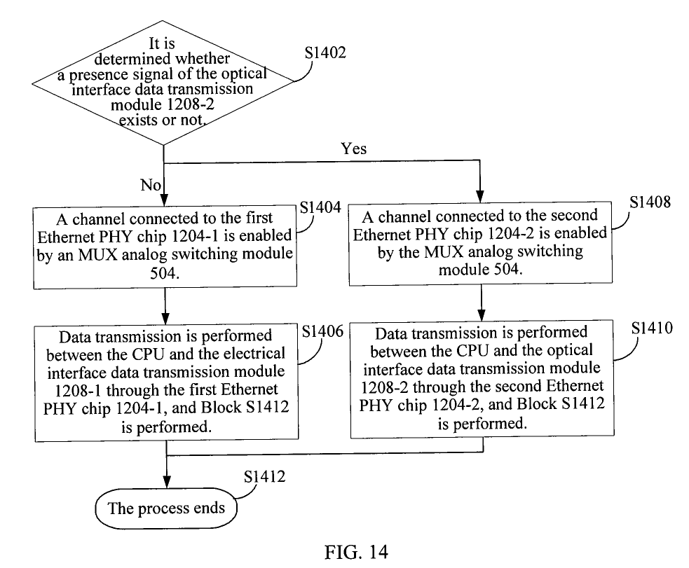

Specifically, FIG. 14 is a flowchart of another method for implementing photoelectric mutex by the Ethernet photoelectric mutex interface device according to the fourth embodiment of the present disclosure. Referring to FIGS. 5 and 12 together, the method includes the following blocks.

In Block S1402, it is determined whether a presence signal of the optical interface data transmission module 1208-2 exists or not; if not, Block 1404 is performed; otherwise, Block 1408 is performed.

In Block S1404, a channel connected to the first Ethernet PHY chip 1204-1 is enabled by an MUX analog switching module 504.

In Block S1406, data transmission is performed between the CPU and the electrical interface data transmission module 1208-1 through the first Ethernet PHY chip 1204-1, and Block S1412 is performed.

In Block S1408, a channel connected to the second Ethernet PHY chip 1204-2 is enabled by the MUX analog switching module 504.

In Block S1410, data transmission is performed between the CPU and the optical interface data transmission module 1208-2 through the second Ethernet PHY chip 1204-2, and Block S1412 is performed.

In Block S1412, the process ends.

In the method for implementing photoelectric mutex by the photoelectric mutex interface device according to the embodiment of the present disclosure, a solution of using two Ethernet PHY chips (for example, PHY chips of the FE) with lower cost and a channel switching module is adopted to implement the photoelectric mutex of the Ethernet, instead of realizing the photoelectric mutex function by adopting high-end products (for example, PHY chips of the GE) in the existing products. Thus, the cost for implementing the photoelectric mutex in the products is reduced, and the utilization rate of resources is improved.

### Embodiment 5

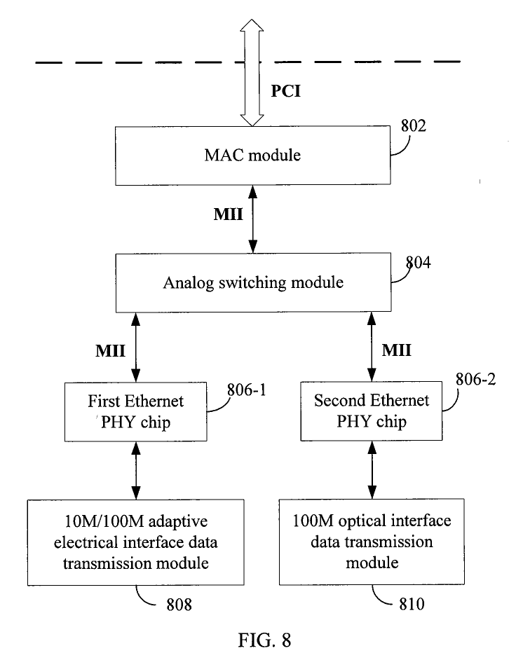

FIG. 8 is a schematic diagram of an Ethernet photoelectric mutex interface device according to an embodiment of the present disclosure. As shown in FIG. 8, the device includes a MAC module 802, an analog switching module 804, a first Ethernet PHY chip 806-1, a second Ethernet PHY chip 806-2, a 10M/100M adaptive electrical interface data transmission module 808 (10/100 BASE-TX), and a 100M optical interface data transmission module 810 (100 BASE-FX).

The MAC module 802 is connected to a CPU through a PCI bus, and is connected to the analog switching module 804 through an MII respectively. The MAC module 802 is adapted to receive downlink data from the CPU through the PCI bus, and sends the downlink data to the analog switching module 804 through the MII. Correspondingly, the MAC module 802 also receives uplink data from the analog switching module 804 through the MII, and sends the received uplink data to the CPU through the PCI bus.

The analog switching module 804 is connected to the MAC module 802 in an uplink direction, and is respectively connected to the first Ethernet PHY chip 806-1 and the second Ethernet PHY chip 806-2 in a downlink direction. The analog switching module 804 is adapted to receive downlink data from the MAC module 802 through the MII, and switch a data channel to an electrical interface transmission mode or an optical interface transmission mode according to a condition that an electrical interface or an optical interface is enabled. Particularly, when the electrical interface is enabled, the analog switching module 804 is adapted to send the received downlink data to the first Ethernet PHY chip 806-1; and when the optical interface is enabled, the analog switching module 804 is adapted to send the received downlink data to the second Ethernet PHY chip 806-2. Correspondingly, the analog switching module 804 is also adapted to receive uplink data from the first Ethernet PHY chip 806-1 or the second Ethernet PHY chip 806-2 through the MII, and sends the uplink data to the MAC module 802 through the MII.

The first Ethernet PHY chip 806-1 is respectively connected to the analog switching module 804 in the uplink direction, and is connected to the 10M/100M adaptive electrical interface data transmission module 808 in the downlink direction. The first Ethernet PHY chip 806-1 is adapted to receive downlink data from the analog switching module 804, and send the received downlink data to the 10M/100M adaptive electrical interface data transmission module 808. Correspondingly, the first Ethernet PHY chip 806-1 is also adapted to receive uplink data from the 10M/100M adaptive electrical interface data transmission module 808 through the MII, and send the uplink data to the analog switching module 804.

The second Ethernet PHY chip 806-2 is respectively connected to the analog switching module 804 in the uplink direction, and is connected to the 100M optical interface data transmission module 810 in the downlink direction. The second Ethernet PHY chip 806-2 is adapted to receive downlink data from the analog switching module 804, and send the received downlink data to the 100M optical interface data transmission module 810. Correspondingly, the second Ethernet PHY chip 806-2 is also adapted to receive uplink data from the 100M optical interface data transmission module 810 through the MII, and send the uplink data to the analog switching module 804.

The 10M/100M adaptive electrical interface data transmission module 808 is connected to the first Ethernet PHY chip 806-1, and is adapted to receive downlink data from the first Ethernet PHY chip 806-1. When the electrical interface is enabled, the 10M/100M adaptive electrical interface data transmission module 808 provides the received downlink data to the device (for example, a router or a switch) connected to the 10M/100M adaptive electrical interface data transmission module. Correspondingly, when the electrical interface is enabled, the 10M/100M adaptive electrical interface data transmission module 808 receives uplink data from a device connected to the 10M/100M adaptive electrical interface data transmission module, and sends the uplink data to the first Ethernet PHY chip 806-1.

The 100M optical interface data transmission module 810 is connected to the second Ethernet PHY chip 806-2, and is adapted to receive downlink data from the second Ethernet PHY chip 806-2. When the optical interface is enabled, the 100M optical interface data transmission module 810 provides the received downlink data to the device (for example, a router or a switch) connected to the 100M optical interface data transmission module 810. Correspondingly, when the optical interface is enabled, the 100M optical interface data transmission module 810 receives uplink data from a device connected to the 100M optical interface data transmission module, and sends the uplink data to the second Ethernet PHY chip 806-2.

Specifically, referring to the photoelectric mutex interface device shown in FIGS. 4 and 5, the difference between the Ethernet photoelectric mutex interface device shown in FIG. 8 and that shown in FIGS. 4 and 5 lies in that, the MAC module 802 and the analog switching module 804 are used to replace the FPGA 402 in FIGS. 4 and 5. The MAC module 802 is respectively connected to the CPU through the PCI bus, and is connected to the analog switching module 804 through the MII.

The MAC module 802 is adapted to provide different control information of a MAC layer.

Specifically, the function of the MAC module 802 includes, but not limited to, converting downlink data received from the CPU through the PCI bus into data suitable for being transmitted in a physical layer of the Ethernet, or converting uplink data received from the physical layer of the Ethernet through the MII into data that can be transmitted to the CPU through the PCI bus.

The analog switching module 804 is adapted to enable a channel connected to the first Ethernet PHY chip 806-1 when no presence signal of the 100M optical interface data transmission module 810 is detected, and perform data transmission between the CPU and the 10M/100M adaptive electrical interface data transmission module 808 through the first Ethernet PHY chip 806-1. When a presence signal of the 100M optical interface data transmission module 810 is detected, the analog switching module 804 is adapted to switch to a channel connected to the second Ethernet PHY chip 806-2 and perform data transmission between the CPU and the 100M optical interface data transmission module 810 through the second Ethernet PHY chip 806-2.

Apparently, those skilled in the art may appreciate that, the electrical interface data transmission module includes, but not limited to, the 10M/100M adaptive electrical interface data transmission module, and the optical interface data transmission module includes, but is not limited to, the 100M optical interface data transmission module.

The architecture of the other parts is similar to the embodiment shown in FIGS. 4 and 5, which thus is not described here repeatedly.

In this embodiment, the interfaces are, for example, the MII and the PCI. However, the interfaces are not limited here. The first Ethernet PHY chip and the second Ethernet PHY chip may be 100M Ethernet PHY chips and the like.

The Ethernet photoelectric mutex interface device according to the embodiment of the present disclosure adopts two Ethernet PHY chips with lower cost and a channel switching module to implement the photoelectric mutex of the 100M Ethernet, instead of realizing the photoelectric mutex function of the Ethernet by using PHY chips with higher cost. Thus, the cost of the equipment for implementing the photoelectric mutex function in products is reduced, and the utilization rate of resources is improved.

### Embodiment 6

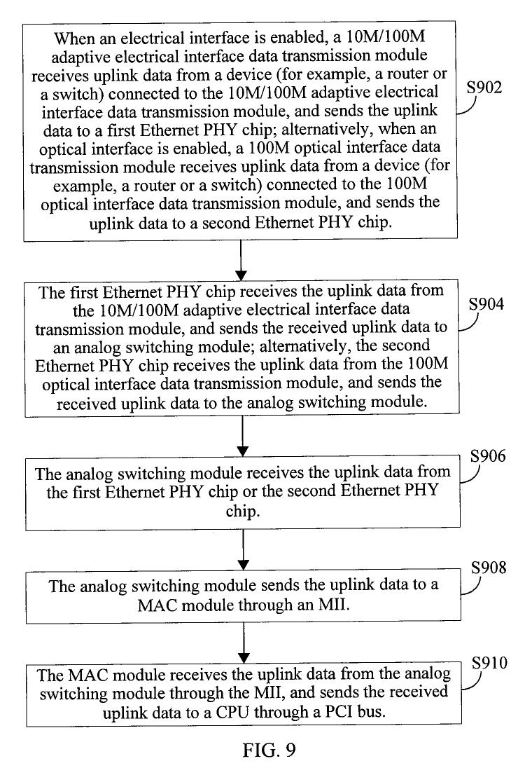

FIG. 9 is a flowchart of a method for implementing photoelectric mutex by an Ethernet photoelectric mutex interface device according to an embodiment of the present disclosure. In an uplink direction, the method includes the following blocks.

In Block S902, when an electrical interface is enabled, a 10M/100M adaptive electrical interface data transmission module receives uplink data from a device (for example, a router or a switch) connected to the 10M/100M adaptive electrical interface data transmission module, and sends the uplink data to a first Ethernet PHY chip; alternatively, when an optical interface is enabled, a 100M optical interface data transmission module receives uplink data from a device (for example, a router or a switch) connected to the 100M optical interface data transmission module, and sends the uplink data to a second Ethernet PHY chip.

In Block S904, the first Ethernet PHY chip receives the uplink data from the 10M/100M adaptive electrical interface data transmission module, and sends the received uplink data to an analog switching module; alternatively, the second Ethernet PHY chip receives the uplink data from the 100M optical interface data transmission module, and sends the received uplink data to the analog switching module.

In Block S906, the analog switching module receives the uplink data from the first Ethernet PHY chip or the second Ethernet PHY chip.

In Block S908, the analog switching module sends the uplink data to a MAC module through an MII.

In Block S910, the MAC module receives the uplink data from the analog switching module through the MII, and sends the received uplink data to a CPU through a PCI bus.

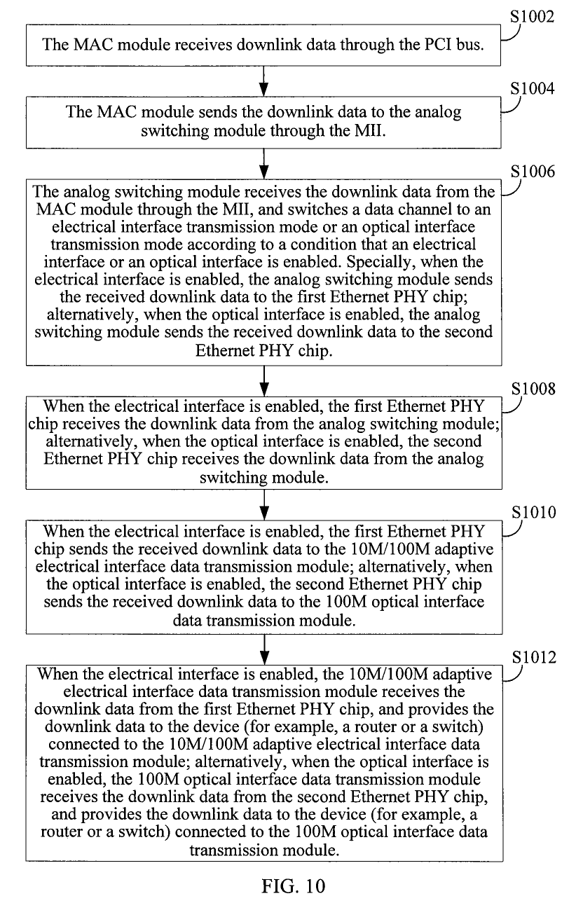

Referring to FIG. 10, in a downlink direction, the method includes the following blocks in a downlink direction.

In Block S1002, the MAC module receives downlink data through the PCI bus.

In Block S1004, the MAC module sends the downlink data to the analog switching module through the MII.

In Block S1006, the analog switching module receives the downlink data from the MAC module through the MII, and switches a data channel to an electrical interface transmission mode or an optical interface transmission mode according to a condition that an electrical interface or an optical interface is enabled. Specially, when the electrical interface is enabled, the analog switching module sends the received downlink data to the first Ethernet PHY chip; alternatively, when the optical interface is enabled, the analog switching module sends the received downlink data to the second Ethernet PHY chip.

In Block S1008, when the electrical interface is enabled, the first Ethernet PHY chip receives the downlink data from the analog switching module; alternatively, when the optical interface is enabled, the second Ethernet PHY chip receives the downlink data from the analog switching module.

In Block S1010, when the electrical interface is enabled, the first Ethernet PHY chip sends the received downlink data to the 10M/100M adaptive electrical interface data transmission module; alternatively, when the optical interface is enabled, the second Ethernet PHY chip sends the received downlink data to the 100M optical interface data transmission module.

In Block S1012, when the electrical interface is enabled, the 10M/100M adaptive electrical interface data transmission module receives the downlink data from the first Ethernet PHY chip, and provides the downlink data to the device (for example, a router or a switch) connected to the 10M/100M adaptive electrical interface data transmission module; alternatively, when the optical interface is enabled, the 100M optical interface data transmission module receives the downlink data from the second Ethernet PHY chip, and provides the downlink data to the device (for example, a router or a switch) connected to the 100M optical interface data transmission module.

In this embodiment, the interfaces are, for example, the MII and the PCI. However, the interfaces are not limited here. The first Ethernet PHY chip and the second Ethernet PHY chip may be 100M Ethernet PHY chips and the like.

In the embodiment of the present disclosure, a solution of using two Ethernet PHY chips with lower cost (for example, 100M Ethernet PHY chips) is adopted to replace the Ethernet photoelectric mutex interface solution with higher cost. Thus, the cost of the Ethernet photoelectric mutex interface device is reduced, and the utilization rate of transmission resources is improved.

### Embodiment 7

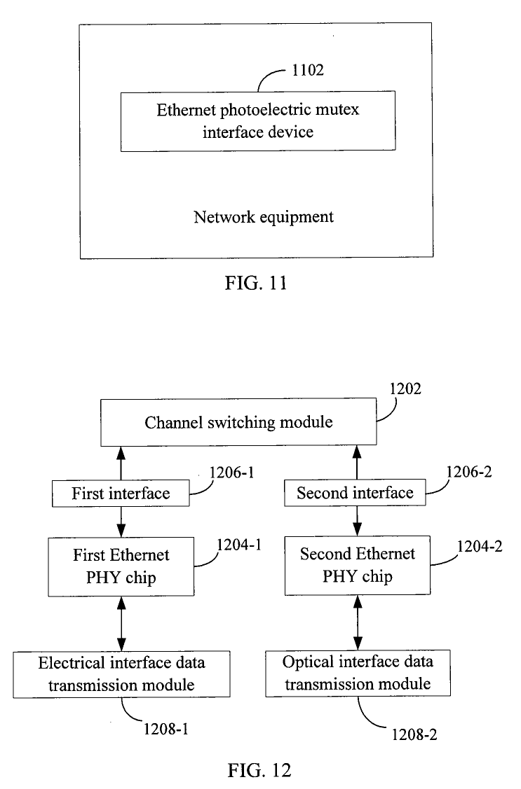

FIG. 11 is a schematic diagram of network equipment according to an embodiment of the present disclosure. Referring to the FIG. 11, the network equipment includes an Ethernet photoelectric mutex interface device 1102. The Ethernet photoelectric mutex interface device 1102 may be the Ethernet photoelectric mutex interface device described in the above embodiments, which thus is not described here repeatedly.

In this embodiment, the network equipment may be a switch, a router, a digital subscriber line access multiplexer (DSLAM), a base station, or a gateway.

The network equipment according to the embodiment of the present disclosure adopts two Ethernet PHY chips with lower cost and a channel switching module to implement the photoelectric mutex of the 100M Ethernet, instead of realizing the photoelectric mutex function of the 100M Ethernet by using the PHY chips with higher cost. Thus, the cost for implementing the photoelectric mutex function in products is reduced, and the utilization rate of resources is improved.

To sum up, in the Ethernet photoelectric mutex interface device, the method for implementing photoelectric mutex by an Ethernet photoelectric mutex interface device, and the network equipment according to the embodiments of the present disclosure, two low-end PHY chips of the FE and a channel switching module, instead of the PHY chips of the GE in the existing products, are adopted to implement the photoelectric mutex function. Thus, the cost for implementing the photoelectric mutex is reduced, and the utilization rate of transmission resources is improved.

Person skilled in the art may realize that, the units and steps of algorithms illustrated in the examples according to the embodiments disclosed herein can be implemented through electronic hardware, computer software, or any combination thereof. To clearly illustrate the interchangeability between the hardware and the software, the composition and steps of the examples are described in general according to the functions thereof. The specific implementation of the functions through hardware or software is determined by specific applications and constrains in the design of the technical solutions. Those skilled in the art can adopt different methods to implement the functions described herein in different specific applications, which may not be considered as departing from the scope of the present disclosure.

The methods or the steps of algorithms according to the embodiments disclosed herein can be implemented through hardware, software modules executed by processors, or any combination thereof. The software modules may be stored in a random access memory (RAM), a memory, a read-only memory (ROM), an electrically programmable ROM, an electrically erasable programmable ROM, a register, a hard disk, a removable disk, a CD-ROM, or a storage medium of any other type.

The above descriptions are merely specific embodiments of the present disclosure. It should be noted that persons of ordinary skill in the art can make modifications or variations to the present disclosure without departing from the spirit of the present disclosure, and such modifications and variations shall fall within the protective scope of the present disclosure.

What is claimed is:

1. An Ethernet photoelectric mutex interface device, comprising: a channel switching module, a first Ethernet physical layer (PHY) chip, and a second Ethernet PHY chip, wherein
the channel switching module is respectively connected with the first Ethernet PHY chip and the second Ethernet PHY chip, and is adapted to perform uplink or downlink data transmission through the first Ethernet PHY chip, and when a presence signal of an optical interface data transmission module is detected, perform uplink or downlink data transmission through the second Ethernet PHY chip.

2. The Ethernet photoelectric mutex interface device according to claim 1, wherein the channel switching module comprises a first interface and a second interface, and the channel switching module is connected with the first Ethernet PHY chip through the first interface and is connected with the second Ethernet PHY chip through the second interface.

3. The Ethernet photoelectric mutex interface device according to claim 1, wherein the Ethernet photoelectric mutex interface device further comprises a first interface and a second interface, and the channel switching module is connected with the first Ethernet PHY chip through the first interface and is connected with the second Ethernet PHY chip through the second interface.

4. The Ethernet photoelectric mutex interface device according to claim 1, wherein the first Ethernet PHY chip comprises 100M Ethernet PHY chips, and the second Ethernet PHY chip comprises 100M Ethernet PHY chips.

5. The Ethernet photoelectric mutex interface device according to claim 1, further comprising:
an electrical interface data transmission module, connected to the first Ethernet PHY chip, and adapted to perform uplink or downlink data transmission with the channel switching module through the first Ethernet PHY chip; and
the optical interface data transmission module, connected to the second Ethernet PHY chip, and adapted to perform uplink or downlink data transmission with the channel switching module through the second Ethernet PHY chip.

6. The Ethernet photoelectric mutex interface device according to claim 5, wherein the channel switching module comprises a media access control (MAC) sub-module and an analog switching sub-module, wherein
the MAC sub-module is respectively connected to a central processing unit (CPU) and the analog switching sub-module, and is adapted to convert downlink data received from the CPU into data suitable for being transmitted in a physical layer of the Ethernet and transmit the data to the analog switching sub-module, and/or to convert uplink data received from the analog switching sub-module into data suitable for being transmitted to the CPU and transmit the data to the CPU; and
the analog switching sub-module is adapted to enable a channel connected to the first Ethernet PHY chip when no presence signal of the optical interface data transmission module is detected, and perform uplink or downlink data transmission between the CPU and the electrical interface data transmission module through the first Ethernet PHY chip; and is further adapted to switch the channel connected to the first Ethernet PHY chip to a channel connected to the second Ethernet PHY chip when the presence signal of the optical interface data transmission module is detected, and perform uplink or downlink data transmission between the CPU and the optical interface data transmission module through the second Ethernet PHY chip.

7. The Ethernet photoelectric mutex interface device according to claim 5, wherein the channel switching module is a Field Programmable Gate Array (FPGA), and the FPGA comprises a media access control (MAC) sub-module and an multiplex (MUX) analog switching sub-module, wherein
the MAC sub-module is respectively connected to a central processing unit (CPU) and the MUX sub-module, and is adapted to convert downlink data received from the CPU into data suitable for being transmitted in a physical layer of the Ethernet and transmit the data to the analog switching sub-module, and/or to convert uplink data received from the analog switching sub-module into data suitable for being transmitted to the CPU and transmit the data to the CPU; and
the MUX analog switching sub-module is adapted to enable a channel connected to the first Ethernet PHY chip when no presence signal of the optical interface data transmission module is detected, and perform uplink or downlink data transmission between the CPU and the electrical interface data transmission module through the first Ethernet PHY chip; and is further adapted to switch the channel connected to the first Ethernet PHY chip to a channel connected to the second Ethernet PHY chip when the presence signal of the optical interface data transmission module is detected, and perform uplink or downlink data transmission between the CPU and the optical interface data transmission module through the second Ethernet PHY chip.

8. The Ethernet photoelectric mutex interface device according to claim 5, wherein the type of the electrical interface data transmission module comprises a 10M/100M adaptive electrical interface data transmission module.

9. The Ethernet photoelectric mutex interface device according to claim 5, wherein the type of the optical interface data transmission module comprises a 100M optical interface data transmission module.

10. A method for implementing photoelectric mutex, comprising:
connecting with a first Ethernet physical layer (PHY) chip, and performing uplink or downlink data transmission through the first Ethernet PHY chip; and
switching the connection with the first Ethernet PHY chip to a connection with a second Ethernet PHY chip through a second interface when a presence signal of an optical interface data transmission module is detected, and performing uplink or downlink data transmission through the second Ethernet PHY chip.

11. The method for implementing photoelectric mutex according to claim 10, wherein
the connecting to the first Ethernet PHY chip and performing uplink or downlink data transmission through the first Ethernet PHY chip comprises: connecting to the first Ethernet PHY chip through a first interface, and performing uplink or downlink data transmission through the first Ethernet PHY chip; and
the switching the connection with the first Ethernet PHY chip to the connection with the second Ethernet physical layer (PHY) chip when the presence signal of an optical interface data transmission module is detected, and performing uplink or downlink data transmission through the second Ethernet PHY chip comprises: when the presence signal of the optical interface data transmission module is detected, switching the connection with the first Ethernet PHY chip through the first interface to the connection with the second Ethernet PHY chip through a second interface, and performing uplink or downlink data transmission through the second Ethernet PHY chip.

12. The method for implementing photoelectric mutex according to claim 10, wherein the first Ethernet PHY chip comprises 100M Ethernet PHY chips, and the second Ethernet PHY chip comprises 100M Ethernet PHY chips.

13. The method for implementing photoelectric mutex according to claim 11, wherein
the performing uplink or downlink data transmission through the first Ethernet PHY chip comprises: performing uplink or downlink data transmission between a channel switching module connected to the first Ethernet PHY chip and an electrical interface data transmission module connected to the first Ethernet PHY chip through the first Ethernet PHY chip; and
the performing uplink or downlink data transmission through the second Ethernet PHY chip comprises: performing uplink or downlink data transmission between the channel switching module connected to the second Ethernet PHY chip and the optical interface data transmission module connected to the second Ethernet PHY chip through the second Ethernet PHY chip.

14. The method for implementing photoelectric mutex according to claim 11, wherein
the connecting to the first Ethernet PHY chip through the first interface and performing uplink or downlink data transmission through the first Ethernet PHY chip comprises:
when no presence signal of the optical interface data transmission module is detected, enabling a channel connected with the first Ethernet PHY chip and performing uplink or downlink data transmission between a central processing unit (CPU) and an electrical interface data transmission module through the first Ethernet PHY chip; and
the when the presence signal of the optical interface data transmission module is detected, switching the connection with the first Ethernet PHY chip through the first interface to the connection with the second Ethernet PHY chip through the second interface, and performing uplink or downlink data transmission through the second Ethernet PHY chip comprises:
when the presence signal of the optical interface data transmission module is detected, switching the channel connected with the first Ethernet PHY chip to a channel connected with the second Ethernet PHY chip and performing uplink or downlink data transmission between the CPU and the optical interface data transmission module through the second Ethernet PHY chip.

15. A network equipment, comprising a central processing unit (CPU) and an Ethernet photoelectric mutex interface device, wherein the Ethernet photoelectric mutex interface device comprises a channel switching module, a first Ethernet physical layer (PHY) chip, and a second Ethernet PHY chip, wherein
the channel switching module is respectively connected with the first Ethernet PHY chip and the second Ethernet PHY chip, and is adapted to perform uplink or downlink data transmission through the first Ethernet PHY chip, and when a presence signal of an optical interface data transmission module is detected, perform uplink or downlink data transmission through the second Ethernet PHY chip.

16. The network equipment according to claim 15, wherein the first Ethernet PHY chip comprises 100M Ethernet PHY chips, and the second Ethernet PHY chip comprises 100M Ethernet PHY chips.

17. The network equipment according to claim 15, wherein the Ethernet photoelectric mutex interface device further comprises:
an electrical interface data transmission module, connected to the first Ethernet PHY chip, and adapted to perform uplink or downlink data transmission with the channel switching module through the first Ethernet PHY chip; and
the optical interface data transmission module, connected to the second Ethernet PHY chip, and adapted to perform uplink or downlink data transmission with the channel switching module through the second Ethernet PHY chip.

18. The network equipment according to claim 17, wherein the channel switching module is further adapted to enable a channel connected to the first Ethernet PHY chip when no presence signal of the optical interface data transmission module is detected, and perform uplink or downlink data transmission between the CPU and the electrical interface data transmission module through the first Ethernet PHY chip; and switch the channel connected to the first Ethernet PHY chip to a channel connected to the second Ethernet PHY chip when the presence signal of the optical interface data transmission module is detected, and perform uplink or downlink data transmission between the CPU and the optical interface data transmission module through the second Ethernet PHY chip.

19. The network equipment according to claim 15, wherein the type of the network equipment comprises at least one of:
a switch, a router, a digital subscriber line access multiplexer (DSLAM), a base station, and a gateway.

20. A computer readable storage medium comprising program codes for instructing one or more digital processors to implement photoelectric mutex, the program codes including:
instructions for connecting to a first Ethernet physical layer (PHY) chip and performing uplink or downlink data transmission through the first Ethernet PHY chip; and
instructions, when a presence signal of an optical interface data transmission module is detected, for switching the connection with the first Ethernet PHY chip to a connection with a second Ethernet physical layer (PHY) chip, and performing uplink or downlink data transmission through the second Ethernet PHY chip.
